(19) United States
(12) Patent Application Publication
(10) Pub. No.: US 2025/0223503 A1
(43) Pub. Date: Jul. 10, 2025

(54) METHOD TO MANUFACTURE BIOFUEL

(71) Applicant: SIXRING INC., Calgary (CA)

(72) Inventors: Tenzin LEKSMON, Calgary (CA); Emhemmed YOUSSEF, Calgary (CA); Markus WEISSENBERGER, Calgary (CA)

(21) Appl. No.: 18/853,369

(22) PCT Filed: Mar. 31, 2023
(86) PCT No.: PCT/CA2023/050438

§ 371 Date: Oct. 1, 2024

(30) Foreign Application Priority Data
Apr. 1, 2022 (CA) 3154055

(51) Int. Cl. C10G 3/00; C10G 19/00

(52) U.S. Cl. CPC C10G 3/52; C10G 19/00; C10G 2300/1014

(57) ABSTRACT

Method to produce biofuel using a lignin-rich feedstock, said method comprise; —providing a lignin-rich feedstock, wherein said lignin-rich feedstock comprises more than 60 wt % of lignin-based compounds obtained from delignification of biomass, where said lignin-based compounds are selected from the group consisting of: lignin-derived monomers, lignin-derived dimers, lignin-derived oligomers and combinations thereof; —performing a hydrodeoxygenation reaction on said lignin-rich feedstock, wherein the hydrodeoxygenation reaction is carried out in a hydrogen-rich source at a temperature ranging from 300° C. to 400° C. under a H2 pressure ranging from 15 to 75 bar, more preferably 35 bar, in the presence of a catalyst adapted for HDO reactions, for a period of time sufficient to result in an upgraded oil having a total acid number (TAN) of about 10-35 mg KOH/g and viscosity of 4-30 cP.

### FIELD OF THE INVENTION

The present invention is directed to a novel single stage process method of manufacturing biofuel, more specifically a method which uses a hemicellulose and lignin-rich stream to generate drop-in biofuel.

### BACKGROUND OF THE INVENTION

In recent years, clean and renewable energy sources are urgently needed to partially or completely replace the fossil fuels (e.g., natural gas, petroleum, and coal) due to their depleted reserves and detrimental environmental impacts (T. J. Lindroos, E. Miki, K. Koponen, I. Hannula, J. Kiviluoma, and J. Raitila, “Replacing fossil fuels with bioenergy in district heating—Comparison of technology options,” Energy, vol. 231, 2021, doi: 10.1016/j.energy.2021.120799; and T. E. Amidon and S. Liu, “Water-based woody biorefinery,” Biotechnol. Adv., vol. 27, no. 5, pp. 542-550, 2009, doi: 10.1016/j.biotechadv.2009.04.012.) Bio-fuels derived from renewable resources have inherent benefits of resource abundancy and carbon neutrality. Fast pyrolysis (operating at >500° C., in inert atmosphere) is the most common thermochemical process for biomass conversion and by far the only industrially realized approach to convert dry biomass into liquid fuels (known as bio-oil or pyrolysis oil) with a higher heating value (HHV) of 15-20 MJ/kg [3]. Whereas, hydrothermal liquefaction (HTL), operating at 200-400° C. under high pressure up to 20 MPa, is a more suitable and advantageous process for converting wet biomass (microalgae) or organic wastes (such as kitchen waste, wastewater sludge) directly to bio-crude oils (or HTL bio-oils) with an HHV of 25-30 MJ/kg [L. Plante et al., “Bioenergy from biofuel residues and waste,” Water Environ. Res., vol. 91, no. 10, pp. 1199-1204, 2019, doi: 10.1002/wer.1214.].

Although the use of bio-oils offers environmental benefits by reducing CO₂ emission, the poor quality of bio-oil, e.g., thermal-instability, high viscosity and acidity, and low heating value, makes it unsuitable for direct applications as drop-in fuels [V.T.T.Energy, “99/00150 Characterization of biomass-based flash pyrolysis oils,” Fuel Energy Abstr., vol. 40, no. 1, pp. 15-16, 1999, doi: 10.1016/s0140-6701(99)92423-2; Z. Si, X. Zhang, C. Wang, L. Ma, and R. Dong, “An overview on catalytic hydrodeoxygenation of pyrolysis oil and its model compounds,” Catalysts, vol. 7, no. 6, pp. 1-22, 2017, doi: 10.3390/cata17060169; and A. Pawar, N. L. Panwar, and B. L. Salvi, “Comprehensive review on pyrolytic oil production, upgrading and its utilization,” J. Mater. Cycles Waste Manag., vol. 22, no. 6, pp. 1712-1722, 2020, doi: 10.1007/s10163-020-01063-w]. For example, the water content of pyrolysis bio-oil (15-30 wt. %) is considerably greater than that of petroleum crude oil (<1 wt. %). High water content in the oil could cause problems to the engine ignition, not to mention the significantly lower energy content [M. H. Marzbali et al., “Wet organic waste treatment via hydrothermal processing: A critical review,” Chemosphere, vol. 279, p. 130557, 2021, doi: 10.1016/j.chemosphere.2021.130557]. In addition, oxygen (O₂) content in the bio-oil from fast pyrolysis (35-50 wt. %) is much larger than that of petroleum crude oil (<1 wt. %). Such high 0 content makes bio-oil dissolvable in polar solvents like acetone and methanol, but poorly mixable with fossil fuels [S. Zhang et al., “Liquefaction of biomass and upgrading of bio-oil: A review,” Molecules, vol. 24, no. 12, pp. 1-30, 2019, doi: 10.3390/molecules24122250]. Besides, the presence of high 02 content in bio-oil results in a low stability and strong acidity/corrosiveness and hence some negative impacts on storage and transportation of the oil, as well as some corrosion issues for bio-oil downstream upgrading/processing reactors [M. Zhang et al., “A review of bio-oil upgrading by catalytic hydrotreatment: Advances, challenges, and prospects,” Mol. Catal., vol. 504, no. September 2020, p. 111438, 2021, doi: 10.1016/j.mcat.2021.111438].

Catalytic hydro-de-oxygenation (HDO) is one of the most promising ways to upgrade bio-oils. It can efficiently reduce oxygen content of pyrolysis bio-oil using high pressure H₂, while maintaining a high oil yield [C. Guo, K. T. V. Rao, Z. Yuan, S. (Quan) He, S. Rohani, and C. (Charles) Xu, “Hydrodeoxygenation of fast pyrolysis oil with novel activated carbon-supported NiP and CoP catalysts,” Chem. Eng. Sci., vol. 178, pp. 248-259, 2018, doi: 10.1016/j.ces.2017.12.048]. However, this process normally operates under high pressure hydrogen gas, which raises safety concerns and process costs [W. Jin, L. Pastor-Perez, D. K. Shen, A. Sepnlveda-Escribano, S. Gu, and T. Ramirez Reina, “Catalytic Upgrading of Biomass Model Compounds: Novel Approaches and Lessons Learnt from Traditional Hydrodeoxygenation—a Review,” ChemCatChem, vol. 11, no. 3, pp. 924-960, 2019, doi: 10.1002/cctc.201801722].

In light of the state of the art, there is still a need for an approach which efficiently converts biomass into a valuable bio-oil all the while overcoming one or many of the drawbacks known from the commonly applied methods whether these drawbacks are from the feedstock or the upgrading process of the oil obtained from the feedstock.

### SUMMARY OF THE INVENTION

According to an aspect of the present invention, there is provided a method to convert biomass into a biofuel.

The applicant has a patent-pending delignification process produces a bio-oil feedstock that is substantially free of cellulose derivatives and hence its composition is enhanced compared to pyrolysis bio-oil. The pyrolysis of delignified biomass thermally decomposes the liquid portion of the delignified biomass in the absence of air to produce a liquid (bio-oil) through the application of a high heat transfer rate to the biomass particles. The applicant's patent-pending delignification process separates cellulose from the other biomass constituents (lignin and hemicellulose) at a recovery rate of +99% and depolymerizes lignin and hemicellulose into a liquid-rich organic liquid called Lignin-Hemicellulose-Depolymerization-Organics (LHDO). The applicant's LHDO contains virtually no aldehydes and at least 70%, preferably at least 85%, more preferably at least 95% of the carboxylic acids are converted once the LHDO is upgraded using hydrodeoxygenation (HDO). This eliminates the need for bio-oil aldehyde's role in bio-oil stability from thermal application or stability over time. Aldehydes present in pyrolysis bio-oil react with sugars to form higher molecular weight resins and oligomers via polymerization and condensation; oligomerization reactions lead to coke formation, which is highly undesirable in bio-oils. Furthermore, the applicant's LHDO produces minimum and almost negligible char/coke during the HDO process and the upgraded LHDO is completely miscible with jet, diesel, VGO and gasoline fuels without the need for pre-treatment step used for pyrolysis bio-oil by oxidation followed by mild temperature hydrotreating stage to eliminate polymerization that occurred through during hydrocracking process.

It is noteworthy to point out that current pyrolysis of biomass generally yields a large amount of bio-char (up to 30-40%). This is highly undesirable as bio-char is low in value and the potential to use the remaining bio-oil as a fuel additive which is the high value product is greatly diminished to the high amount of conversion of biomass into bio-char.

According to an aspect of the present invention, there is provided a method to produce biofuel using a hemicellulose and lignin-rich feedstock, said method comprise;
providing a lignin-rich feedstock, wherein said lignin-rich feedstock comprises more than 60 wt % of lignin-based compounds obtained from delignification of biomass, where said lignin-based compounds are selected from the group consisting of: lignin-derived monomers, lignin-derived dimers, lignin-derived oligomers and combinations thereof;
performing a hydrodeoxygenation reaction on said lignin-rich feedstock, wherein the hydrodeoxygenation reaction is carried out in a hydrogen-rich source at a temperature ranging from 250° C. to 400° C. under a H₂ pressure ranging from 15 to 75 bar, more preferably 35 bar, in the presence of a catalyst adapted for HDO reactions, for a period of time sufficient to result in an upgraded oil having a TAN of about 10-35 mg KOH/g and viscosity of 4-30 cP.

Preferably, said lignin-rich feedstock comprises more than 80 wt % of lignin-based compounds obtained from delignification of biomass, the balance of the feedstock being mainly made up of hemicellulose. More preferably, said lignin-rich feedstock comprises more than 85 wt % of lignin based compounds obtained from delignification of biomass, the balance of the feedstock being mainly made up of hemicellulose. Even more preferably, said lignin rich feedstock comprises more than 90 wt % of lignin based compounds obtained from delignification of biomass. Yet even more preferably, said lignin rich feedstock comprises more than 95 wt % of lignin-based compounds obtained from delignification of biomass. According to a preferred embodiment of the method of the present invention, the lignin rich feedstock comprises more than 97.5 wt % of lignin-based compounds obtained from delignification of biomass. Preferably, the lignin-rich feedstock is essentially devoid of any cellulose. According to one embodiment of the present invention, the lignin-rich feedstock contains a fraction of the initial hemicellulose content of the biomass used. For example, in such cases, the lignin-rich feedstock contains about 15-20% of the initial hemicellulose content of the biomass used.

According to a preferred embodiment of the method of the present invention, the said lignin-rich feedstock also comprises dissolved hemicellulose resulting from a prior delignification reaction where said lignin-rich feedstock was generated According to a preferred embodiment of the method of the present invention, the method further comprises a pretreatment procedure using an alkaline salt for the removal of sulfuric acid present in the crude bio-oil.

According to a preferred embodiment of the method of the present invention, the alkaline salt is a hydroxide salt selected from the group consisting of KOH; Ca(OH)₂; NaOH; and the like. Preferably, said alkaline salt is Ca(OH)₂. According to a preferred embodiment of the present invention, the catalyst is a Ru/C catalyst. The person skilled in the art will understand that catalysts which are commonly used in hydrodeoxygenation reaction can be employed in the method according to a preferred embodiment of the present and the interpretation of catalyst should not be limited to the one employed in the accompanying examples.

According to a preferred embodiment of the method of the present invention, said period of time is about 2 h.

According to a preferred embodiment of the method of the present invention, the temperature is about 350° C.

According to a preferred embodiment of the method of the present invention, said hydrogen-rich source is selected from the group consisting of: alcohols, for example, ethanol; gaseous hydrogen; and the like.

According to a preferred embodiment of the method of the present invention, said upgraded oil has a char content of less than 10% wt. Preferably, said upgraded oil has a char content of less than 5 wt. %. Preferably, said upgraded oil has a char content of less than 2 wt. %. More preferably, said upgraded oil has a char content of less than 1 wt. %.

According to a preferred embodiment of the method of the present invention, the process further comprises a step of recovering the upgraded oil.

According to another aspect of the present invention, there is provided a method to produce biofuel using a lignin-rich feedstock, said method comprise;
providing a liquid lignin-rich LHDO feedstock obtained from a delignification process which separates cellulose from lignin and hemicellulose and depolymerizes lignin and hemicellulose into mainly monomers and dimers thereof;
performing a hydrodeoxygenation reaction on said lignin-rich feedstock, wherein the hydrodeoxygenation reaction is carried out in a hydrogen-rich source a temperature ranging from 300° C. to 400° C. under a H₂ pressure ranging from 15 to 75 bar, more preferably 35 bar, in the presence of a catalyst adapted for HDO reactions, for a period of time sufficient to result in an upgraded oil having a TAN of about 10-35 mg KOH/g and viscosity of 4-30 cP.

Preferably, said LHDO contains virtually no aldehydes.

According to a preferred embodiment of the method of the present invention, all acids are converted once the LHDO is upgraded in the hydrodeoxygenation (HDO) reaction. Preferably also, the LHDO can be upgraded in a hydrodesulfurization (HDS) reaction. Preferably also, the LHDO can be upgraded in a hydrodenitrogenation (HDN) reaction.

### BRIEF DESCRIPTION OF THE FIGURES

Features and advantages of embodiments of the present application will become apparent from the following detailed description and the appended figures, in which:

FIG. 1a illustrates the process flow diagram of the LHDO bio-oil upgrading system according to a preferred embodiment of the present invention;

FIG. 1b illustrates the process flow diagram of the LHDO bio-oil upgrading system according to a preferred embodiment of the present invention;

FIG. 2 is a FTIR spectra of the SWR crude oil and the upgraded oil at 350° C.; and

FIG. 3 is a photograph of a 2 wt. % upgraded oil obtained according to a preferred embodiment of the present invention blended with 98 wt. % gasoline or virgin gas oil (VGO)—((a) 300° C. upgraded oil with gasoline; (b) 350° C. upgraded oil with gasoline; (c) 300° C. upgraded oil with VGO; (d) 350° C. upgraded oil with VGO).

### DETAILED DESCRIPTION OF THE INVENTION

The description that follows, and the embodiments described therein, is provided by way of illustration of an example, or examples, of particular embodiments of the principles of the present invention. These examples are provided for the purposes of explanation, and not limitation, of those principles and of the invention.

According to an aspect of the present invention, there is provided a method to convert biomass into a biofuel. Preferably, the delignification is carried out at much milder conditions that conventional kraft process or other widely employed delignification approach. Preferably also, this result is a completely cellulose-free stream of lignin and hemicellulose depolymerization organics (LHDO).

Single-Stage Reaction for Catalytic Upgrading of Biomass Origin Bio-Oil into a Drop-In Fuel

According to an aspect of the present invention, the process disclosed herein provides for complete upgrading and production of drop-in fuels from lignocellulosic biomass (such as found in wood, trees, straw, agricultural waste, and waste paper).

According to a preferred embodiment of the method of the present invention, the process utilizes a unique hemicellulose and lignin-rich oil from the crude bio-oil produced using the Applicant's patented delignification process. The aforementioned crude bio-oil is produced without the cellulose portion of the biomass which enhances its properties and makes it more suitable and easily upgraded to drop-in fuels. The hemicellulose and lignin-rich oil stream refers to an oil resulting from the delignification of lignocellulosic biomass. According to a preferred method of the present invention, the hemicellulose and lignin-rich oil is obtained as a byproduct of delignification using milder conditions (temperature and pressure) than conventional chemical delignification such as those used during the kraft process.

According to a preferred embodiment of the method of the present invention, the delignification of the biomass was carried out as follows. In a 10 L glass reactor vessel 3,368 g H₂SO₄ (93%), 3,746 g H₂O₂ (29%), 576 g H₂O and 310 g of a modifier (such as a taurine-related compound) were mixed to a molar ratio of 10:10:10:1. This modified acid/peroxide blend can be used to delignify lignocellulosic biomass to produce cellulose. When biomass (wood shavings at a 5% mass loading) is added to this blend at this scale the reaction is very exothermic and will run away. To prevent a runaway reaction which would result in degradation of cellulose and keeping the mixture in control, small amounts of water (500 g each) are added to the reactor when the mixture reaches certain predetermined temperatures: 35° C. (1^{st} addition of water); 37° C. (2^{nd} addition of water); 39° C. (1^{st} addition of water); and 41° C. (4^{th} addition of water, until the temperature increase in the reactor is small enough to keep the reaction going, but not run away. In cases when too much water is added, the reaction stops and the biomass will not be delignified completely. No external cooling was applied in any of the experiments. The delignification of the wood shavings was thus carried out at low temperatures and at atmospheric pressure. It is worth noting that external cooling can be applied in another preferred embodiment.

The resulting streams of the above exemplary process include: a cellulose stream comprising solid cellulose fibers and a lignin-rich stream comprising the lignin removed from the biomass as well as dissolved hemicellulose depolymerized during the delignification and present in the lignin-rich liquid phase.

According to a preferred embodiment of the method of the present invention, one of the advantages of this approach is that compared to other approaches using the entire biomass to generate biofuel, this approach focusses on the LHDO present within the lignin-rich stream. Consequently, the portion of aromatic carbons (present on lignin and lignin monomers, dimers and oligomers resulting from the delignification) is substantially higher than in the processes which employ the entire biomass (cellulose, lignin and hemicellulose). For example, in softwood trees, the proportion of cellulose is in the range of 40-50%, the percentage of lignin can range from 30-40% and the remaining balance is hemicellulose. By removing the primary constituent of lignocellulosic biomass (cellulose) from treatment to manufacture biofuel, one increases the aromatic carbon compositions and thus increases the value of the biofuel.

According to another aspect of the present invention, there is provided a process to perform a controlled exothermic delignification of biomass, said process comprising the steps of
providing a vessel;
providing biomass comprising lignin, hemicellulose and cellulose fibers into said vessel;
providing an aqueous acidic composition comprising a sulfuric acid component;
providing a peroxide component;
providing a modifier;
exposing said biomass to said sulfuric acid source and peroxide component, creating a reaction mass;
allowing said sulfuric acid source and peroxide component to come into contact with said biomass for a period of time sufficient to a delignification reaction to occur and remove over 97 wt % of said lignin and hemicellulose from said biomass; and
wherein said lignin and hemicellulose are recovered separately from the cellulose, for further processing into a bio-oil.

According to a preferred embodiment of the method of the present invention, the stream of LHDO is exposed to a pH adjustment prior to undergoing upgrading (i.e. HDO reaction).

According to a preferred embodiment of the method of the present invention, the stream of LHDO is substantially free of cellulose (i.e. less than 5 wt. % cellulose). More preferably, the stream of LHDO contains less than 2 wt. % cellulose. Even more preferably, the stream of LHDO contains less than 1 wt. % cellulose. Yet even more preferably, the stream of LHDO contains less than 0.5 wt. % cellulose. Yet even more preferably, the stream of LHDO contains less than 0.1 wt. % cellulose.

It is worthy of mention that almost all efforts for lignocellulosic biomass conversion into fuels have failed due to undesired interactions among the three main biomass constituents; cellulosic ethanol represents a clear example of the aforementioned beside the undesired properties of pyrolysis bio-oil.

According to yet another aspect of the present invention, there is provided a process to delignify biomass, said process comprising the steps of
providing a vessel;
providing biomass comprising lignin, hemicellulose and cellulose fibers into said vessel;
providing an aqueous acidic composition comprising a sulfuric acid component;
providing a peroxide component;
exposing said biomass to said sulfuric acid source and peroxide component, creating a reaction mass;
allowing said sulfuric acid source and peroxide component to come into contact with said biomass for a period of time sufficient to a delignification reaction to occur and remove over 95 wt % of said lignin and hemicellulose from said biomass; and
controlling the temperature of the delignification reaction by addition of water into said vessel.

According to yet another aspect of the present invention, there is provided a process to delignify biomass, said process comprising the steps of
providing a vessel;
providing biomass comprising lignin, hemicellulose and cellulose fibers into said vessel;
providing an aqueous acidic composition comprising a sulfuric acid component;
providing a peroxide component;
exposing said biomass to said sulfuric acid source and peroxide component, creating a reaction mass;
allowing said sulfuric acid source and peroxide component to come into contact with said biomass for a period of time sufficient to a delignification reaction to occur and remove over 95 wt % of said lignin and hemicellulose from said biomass; and
controlling the temperature of the delignification reaction by controlling the addition of biomass into said vessel.

According to a preferred embodiment of the present invention, the biomass comprising lignin, hemicellulose and cellulose fibers is exposed to a modified Caro's acid composition selected from the group consisting of: composition A; composition B and Composition C;

wherein said composition A comprises:
sulfuric acid in an amount ranging from 20 to 70 wt % of the total weight of the composition;
a compound comprising an amine moiety and a sulfonic acid moiety selected from the group consisting of taurine; taurine derivatives; and taurine-related compounds; and
a peroxide;
   wherein said composition B comprises:
an alkylsulfonic acid; and
a peroxide; wherein the acid is present in an amount ranging from 40 to 80 wt % of the total weight of the composition and where the peroxide is present in an amount ranging from 10 to 40 wt % of the total weight of the composition;
   wherein said composition C comprises:
sulfuric acid;
a compound comprising an amine moiety;
a compound comprising a sulfonic acid moiety; and
a peroxide.

According to a preferred embodiment of the present invention, the biomass comprising lignin, hemicellulose and cellulose fibers is exposed to a modified Caro's acid composition for a period of time sufficient to a delignification reaction to occur and remove over 95 wt % of said lignin and hemicellulose from said biomass. Preferably, the stream of LHDO (containing lignin and hemicellulose but essentially free of cellulose) is removed upon completion of the delignification reaction for further processing into biofuel.

According to a preferred embodiment of the present invention, the biomass comprising lignin, hemicellulose and cellulose fibers is pre-treated to remove a large portion of the hemicellulose. Such a treatment will preferably result, after delignification in a higher lignin portion in the recovered liquid.

Preferably, said compound comprising an amine moiety and a sulfonic acid moiety is selected from the group consisting of: taurine; taurine derivatives; and taurine-related compounds.

Preferably, said taurine derivative or taurine-related compound is selected from the group consisting of sulfamic acid; taurolidine; taurocholic acid; tauroselcholic acid; tauromustine; 5-taurinomethyluridine and 5-taurinomethyl-2-thiouridine; homotaurine (tramiprosate); acamprosate; and taurates as well as aminoalkylsulfonic acids where the alkyl is selected from the group consisting of C₁-C₅ linear alkyl and C₁-C₅ branched alkyl. Preferably, said linear alkylaminosulfonic acid is selected form the group consisting of methyl; ethyl (taurine); propyl; and butyl. Preferably, said branched aminoalkylsulfonic acid is selected from the group consisting of: isopropyl; isobutyl; and isopentyl.

According to a preferred embodiment of the present invention, said compound comprising an amine moiety and a sulfonic acid moiety is taurine.

According to a preferred embodiment of the present invention, said sulfuric acid and compound comprising an amine moiety and a sulfonic acid moiety are present in a molar ratio of no less than 3:1.

According to a preferred embodiment of the present invention, said compound comprising an amine moiety is an alkanolamine is selected from the group consisting of monoethanolamine; diethanolamine; triethanolamine; and combinations thereof.

Preferably, said compound comprising a sulfonic acid moiety is selected from the group consisting of alkylsulfonic acids; arylsulfonic acids; and combinations thereof. Preferably, said alkylsulfonic acid is selected from the group consisting of alkylsulfonic acids where the alkyl groups range from C₁-C₆ and are linear or branched; and combinations thereof. More preferably, said alkylsulfonic acid is selected from the group consisting of methanesulfonic acid; ethanesulfonic acid; propanesulfonic acid; 2-propanesulfonic acid; isobutylsulfonic acid; t-butylsulfonic acid; butanesulfonic acid; iso-pentylsulfonic acid; t-pentylsulfonic acid; pentanesulfonic acid; t-butylhexanesulfonic acid; and combinations thereof. According to a preferred embodiment of the present invention, said arylsulfonic acid is selected from the group consisting of toluenesulfonic acid; benzesulfonic acid; and combinations thereof.

According to a preferred embodiment of the present invention, the temperature of the reaction mass is kept below 55° C. for the duration of the delignification reaction. Preferably, the temperature of the reaction mass is kept below 50° C. for the duration of the delignification reaction. According to another preferred embodiment of the present invention, the temperature of the reaction mass is kept below 45° C. for the duration of the delignification reaction. According to a preferred embodiment of the present invention, the temperature of the reaction mass is kept below 40° C. for the duration of the delignification reaction.

According to a preferred embodiment of the present invention, the temperature of the reaction mass is controlled throughout the delignification reaction to subsequent additions of a solvent (water) to progressively lower the slope of temperature increase per minute from less than IT per minute to less than 0.5° C. per minute.

According to another preferred embodiment of the present invention, the temperature of the reaction mass is controlled by an addition of a solvent (water) to reduce the slope of temperature increase per minute of the reaction mass to less than 1° C. per minute.

According to yet another preferred embodiment of the present invention, the temperature of the mixture reaction mass is controlled by a second addition of a solvent (water) to reduce the slope of temperature increase per minute of the reaction mass to less than 0.7° C. per minute.

Preferably, the temperature of the reaction mass is controlled by a third addition of a solvent (water) to reduce the slope of temperature increase per minute of the reaction mass to less than 0.3° C. per minute.

Preferably, the temperature of the reaction mass is controlled by a fourth addition of a solvent (water) to reduce the slope of temperature increase per minute of the reaction mass to less than 0.1° C. per minute.

According to a preferred embodiment of the present invention, the kappa number of the resulting cellulose is below 4.2.

According to a preferred embodiment of the present invention, there is provided a process to delignify biomass using an aqueous acidic composition comprising:
sulfuric acid;
a heterocyclic compound; and
a peroxide.

According to another preferred embodiment of the present invention, there is provided a process to delignify biomass using an aqueous acidic composition comprising:
sulfuric acid;
a heterocyclic compound; and
wherein sulfuric acid and said a heterocyclic compound; are present in a molar ratio of no less than 1:1.

Preferably, the sulfuric acid and said heterocyclic compound are present in a molar ratio ranging from 28:1 to 2:1 More preferably, the sulfuric acid and heterocyclic compound are present in a molar ratio ranging from 24:1 to 3:1. Preferably, the sulfuric acid and heterocyclic compound are present in a molar ratio ranging from 20:1 to 4:1. More preferably, the sulfuric acid and heterocyclic compound are present in a molar ratio ranging from 16:1 to 5:1. According to a preferred embodiment of the present invention, the sulfuric acid and heterocyclic compound are present in a molar ratio ranging from 12:1 to 6:1.

Also preferably, said heterocyclic compound has a molecular weight below 300 g/mol. Also preferably, said heterocyclic compound has a molecular weight below 150 g/mol. More preferably, said heterocyclic compound is a secondary amine. According to a preferred embodiment of the present invention, said heterocyclic compound is selected from the group consisting of imidazole; triazole; and N-methylimidazole.

According to an aspect of the present invention, there is provided a process to delignify biomass, such as wood using an aqueous acidic composition comprising:
sulfuric acid;
a heterocyclic compound; and
a peroxide.
wherein the sulfuric acid and the heterocyclic compound are present in a mole ratio ranging from 2:1 to 28:1.

### Methods

Bio-oil HDO upgrading experiments were performed in a 500 mL stainless steel Parr autoclave reactor (Illinois, USA) which are equipped with a magnetic stirrer, pressure gauge, and thermocouples. The bio-oil was upgraded by HDO in supercritical ethanol (with critical point at 241° C. and 63 bar).

Supercritical ethanol is an effective hydrogen-donating solvent to avoid the risk of utilizing pure hydrogen at small scale experimentation during catalytic upgrading process. It acts as an in-situ hydrogen donor, capable of generating hydroxyl and hydrogen radicals reacted with bio crude oil [[12]J.-H. Lee, I.-G. Lee, J.-Y. Park, and K.-Y. Lee, “Efficient upgrading of pyrolysis bio-oil over Ni-based catalysts in supercritical ethanol,” Fuel, vol. 241, pp. 207-217, 2019, doi: 10.1016/j.fuel.2018.12.025; and R. Jogi et al., “Biocrude production through hydro-liquefaction of wood biomass in supercritical ethanol using iron silica and iron beta zeolite catalysts,” J. Chem. Technol. Biotechnol., vol. 94, no. 11, pp. 3736-3744, 2019, doi: 10.1002/jctb.6181].

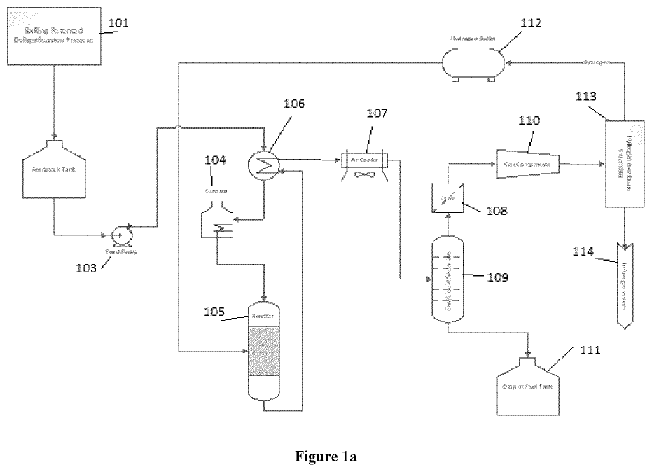

FIG. 1 illustrates the process flow diagram of the LHDO bio-oil upgrading system. The following numbers identify the components of the delignification plant and bio-oil upgrader according to a preferred embodiment of the present invention. The process starts with the delignification of lignocellulosic biomass by a patent-pending delignification process (101), the LHDO is stored in the feedstock tank (102), a feed pump (103) pumps the LHDO to the furnace (104) where the LHDO is heated to the target temperature and then fed to the reactor (105) for the hydrodeoxygenation reaction. In some embodiments, the reactor performs a hydrodesulfurization (HDS) reaction. In some embodiments, the reactor performs a hydrodenitrogenation (HDN) reaction. Subsequently, the upgraded biofuel is sent to a heat exchanger (106), Air Cooler (107), prior to the filtration, and gas/liquid separation at the filtration unit (108) and gas/liquid separator (109). A gas compressor (110) collects the gaseous portion and sends it to a hydrogen membrane separation (113) where the hydrogen is recovered and sent back to the hydrogen storage bullet (112) and the remaining hydrocarbon gas is sent to a fuel gas system (114). From the filter, the liquid portion recovered can be sent to the drop-in fuel tank (111).

FIG. 1b illustrates the process flow diagram of the LHDO bio-oil upgrading system. The following numbers identify the components of the delignification plant and bio-oil upgrader according to a preferred embodiment of the present invention. The process starts with the delignification of lignocellulosic biomass by a patent-pending delignification process (201), the LHDO is stored in the feedstock tank (202), a feed pump (203) pumps the LHDO to the furnace (204) where the LHDO is heated to the target temperature and then fed to the reactor (205) for the hydrodeoxygenation reaction. Subsequently, the upgraded biofuel is sent to a heat exchanger (206), Air Cooler (207), prior to the filtration, and gas/liquid separation at the filtration unit (208) and gas/liquid separator (209). A gas compressor (210) collects the gaseous portion and sends it to a hydrogen membrane separation (213) where the hydrogen is recovered and sent back to the hydrogen storage bullet (212) and the remaining hydrocarbon gas is sent to a fuel gas system (214). From the filter, the liquid portion recovered can be sent to the drop-in fuel tank (211). This liquid can further be sent to a distillation column (215) where the LHDO is fractioned into various hydrocarbons such as sustainable aviation fuel, bio diesel etc and then sent to a hydrocarbon storage tank (216)

According to a preferred embodiment of the present invention, a pretreatment procedure using Ca(OH)₂ was developed to remove sulfuric acid in the feedstock crude bio-oil, and a sulfur-water-removed (SWR) crude bio-oil was obtained for upgrading.

According to a preferred embodiment of the present invention, a 500 mL Parr autoclave reactor was filled with 70 g pretreated bio-oil and 70 g ethanol-water mixed solvent (1:1 w/w), and Ru/C catalyst (10 wt. % of bio-oil on dry base). The reactor was sealed and leak-proof tested with compressed nitrogen and then the residual air inside the reactor was removed by purging and vacuuming with pressurized nitrogen for 3 times. The reactor was then pressurized using pure hydrogen to 35 bar and heated to 300 and 350° C. under constant stirring (˜300 rpm) and held at this temperature for 2 h.

At the end of each run, the reactor was quenched in a water bath. After the reactor was cooled to ambient temperature (˜25° C.), the gaseous products were collected into a gas bag and analyzed using a GC-TCD to determine the gaseous product composition and yield. The reactor was then opened, and the reaction mixture was transferred into a 500 mL beaker. The reactor and stirrer were washed with dichloromethane three times, and the resultant washings were combined with the reaction mixture.

Afterward, the mixture of reaction content and washings was filtered under vacuum. The solid product retained on the filter paper (VWR® Grade 413 Filter Paper) was oven-dried at 105° C. for 12 h to recover solid residue (the used catalyst with carbon/coke deposited), while the filtrate was extracted with dichloromethane to remove water and then evaporated under reduced pressure to remove solvents to recover upgraded oil for further analysis (CHNS elemental compositions, GC-MS, FTIR, etc.). According to a preferred embodiment of the present invention, different commercial refining and hydrogenation catalysts can be considered within the scope of the invention. Preferably, the catalyst is selected from the group consisting of: Ruthenium on activated carbon Ru/C; Ruthenium on activated carbon with ferrous oxide Ru/C—Fe2O3; nickel-molybdenum (NiMo); cobalt-molybdenum (CoMo); and Platinum and palladium on Zeolite Y and HZSM-5. According to a preferred embodiment of the present invention, a combination of the above listed catalyst is employed.

Total acid number (TAN) is an important quality testing for crude oil refining. It provides an indication of the weak organic acids and strong inorganic acids present within oil, and it is essential to maintain and protect equipment, preventing damage in advance. The desired TAN range for drop-in fuel will be in same range of the crude oil to be blended in which ensure the overall TAN for the blended drop-in fuel meets the correspondent standard for that fuel ASTM D8045.

Viscosity has a very critical role in fuel systems, and it affects the fuel's ability to lubricate fuel system components, and atomization. Poor fuel atomization results in poor combustion, which leads to multiple issues such as loss of power and fuel economy. The targeted viscosity range usually depends on the drop-in fuel target. In other words, the viscosity range shall be within the ASTM range values to ensure the conformance with the aforementioned standards once the drop-in blending is completed. This also is governed by the percentage of drop-in fuel value and it usually reflects on the final viscosity number measured of the blended fuel.

The yields of products (upgraded bio-oil, carbon/coke, gas products) were calculated by the wt. % of the product in relation to dry mass of the LHDO crude bio-oil feedstock.

As shown in Table 1, compared with the LHDO crude bio-oil, the upgraded oils according to a preferred embodiment of the present invention, have much lower TAN and viscosity values, in particular for the upgraded oil at 350° C. whose the TAN and viscosity are as low as 2.5 mgKOH/g and 3.4 cP, respectively. Upgrading at 350° C. increased the upgraded oil yield by 17% to a value of (21.2%) from (18.1%) at 300° C.

GC-MS (Agilent Technologies, 5977A MSD, with HP-5MS column) was used to analyze the chemical composition of the volatile fraction of the LHO crude bio-oil and the upgraded oils at 300 and 350° C., and the results are listed in Table 2, after upgrading process. As it is clearly shown, all the acids originally were presented in the LHDO crude bio-oil were removed and disappeared. This supports the hypothesis that these acids were converted into esters. The HDO upgrading also markedly increased the concentrations of hydrocarbons and aromatics in the upgraded oils.

TABLE 1
Results of HDO upgrading of the SWR crude bio-oil

| | | After | After |
|---|---|---|---|
| | | upgrading at | upgrading at |
| | SWR Bio-oil | 300° C. | 350° C. |
| Upgraded oil yield (wt. %) | — | 18.1 ± 1.7 | 21.2 ± 1.3 |
| Solid yield (wt. %) | — | 11.2 ± 0.6 | 15.3 ± 0.9 |
| Gas yield (wt. %) | — | 2 ± 0.2 | 4.1 ± 0.3 |
| WSP + water (wt. %)2 | — | 68.7 ± 2.5 | 59.4 ± 2.5 |
| TAN (mgKOH/g) | n.a.3 | 14.3 ± 1.8 | 10.32 ± 0.4 |
| Density at 25° C. (g/cm3) | n.a. | / | 0.91 ± 0.1 |
| Viscosity at 50° C. (cP) | n.a. | 28.1 ± 0.7 | 3.4 ± 0.4 |

Element (wt. %)

| | | | |
|---|---|---|---|
| C | 14.08 | 63.15 | 72.89 |
| H | 4.21 | 8.06 | 10.06 |
| O | 20.12 | 0.9 | 0.24 |

Moreover, the presence of high oxygen content in bio-oil results in low stability and strong acidity/corrosiveness and hence some negative impacts on storage and transportation of the oil, as well as some corrosion issues for bio-oil downstream upgrading/processing reactors. This is compared to fast pyrolysis bio-oil which is a dark, viscous liquid with a higher presence of water and numerous chemical compounds in a variety of reactive functional groups such as carbonyl compounds, makes bio-oil highly oxygenated, acidic (pH 2.5), and subject to phase separation and polymerization over time or with heating. Furthermore, oxygen (O) content in the bio-oil from fast pyrolysis (35-50 wt. %) is much larger than that of petroleum crude oil (<1 wt. %). Such high oxygen content makes bio-oil dissolvable in polar solvents like acetone and methanol, but poorly miscible with fossil fuels.

Hydrodeoxygenation tests were carried out for lignin-rich oil LHDO at 300° C. & 350° C., 35 bar H₂ pressure, using sets of commercial catalyst, 2 h reaction time, and obtained an upgraded oil that was clear, miscible with hydrocarbon fuels such as diesel, jet fuel, and vacuum gas oil (VGO). The upgraded oil have much lower TAN and viscosity values, in particular for the upgraded oil at 350° C. with a total acid number (TAN) of about 10-35 mg KOH/g and viscosity of 4-30 cP.

After the upgrading process, all acids in the crude bio-oil disappeared. It is hypothesized that the acids were converted into esters. The hydrodeoxygenation (HDO) upgrading also markedly increased the concentrations of hydrocarbons and aromatics in the upgraded oils. Tables 1 and 2 show the comparable results for the raw and upgraded bio-oil.

TABLE 2
Volatile compositions (based on GC-MS) of the SWR crude
bio-oil and upgraded bio-oils from HDO upgrading at
300 and 350° C. for 2 h with 35 bar hydrogen gas

| | Feedstock crude | Upgraded oil | Upgraded oil |
|---|---|---|---|
| | bio-oil | (at 300° C.) | (at 350° C.) |
| Phenols | 9.4 | 6.3 | 22.7 |
| Esters | 0.0 | 21.9 | 16.7 |
| Ketones | 36.5 | 47.1 | 27.4 |
| Aromatics | 0.0 | 0.0 | 5.2 |
| Hydrocarbons | 5.2 | 17.2 | 11.7 |
| Alcohols | 1.3 | 2.1 | 5.2 |
| Others | 28.6 | 5.3 | 11.0 |
| Aldehyde | 0.0 | 0.0 | 0.0 |
| Acids | 18.9 | 0.0 | 0.0 |

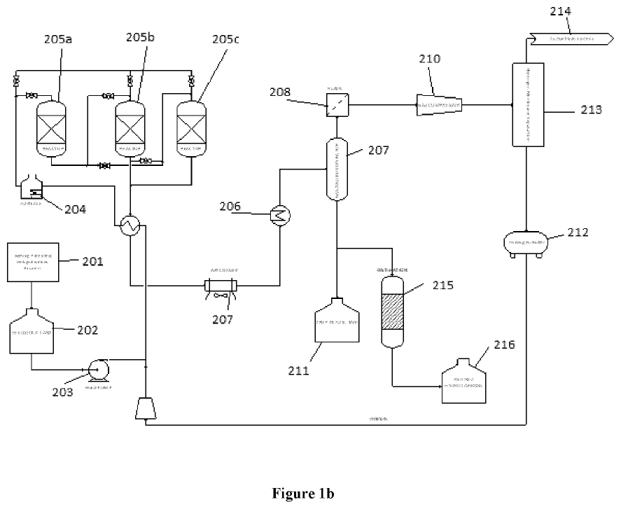

In referring to FIG. 2, FTIR spectra of the SWR crude oil and upgraded oil at 350° C. were also conducted. After the upgrading process, new IR absorption peaks appear between 2970 to 2860 cm⁻¹ and 1460 to 1370 cm⁻¹. It is hypothesized that these peaks can be ascribed as C—H stretch and C—H bend, respectively, which suggest the formation of alkanes during HDO, as evidenced by the GC-MS results. Besides, C═C stretch at 1600 cm⁻¹ and C═C bend at 730 cm⁻¹ indicated the presence of aromatics in the upgraded oil, as confirmed by the GC-MS results (Table 2). Moreover, the IR peaks of SWR oil 3300 cm⁻¹ (OH stretch), 1147 cm⁻¹ (C—O stretch), and 1025 cm⁻¹ (S═O stretch) almost all disappear in the upgraded oil, suggesting effective hydro-de-oxygenation (HDO), and hydro-de-sulfurization (HDS) during the HDO upgrading. The aforementioned are in excellent agreement with the chemical analysis results obtained via elemental analysis.

According to a preferred embodiment of the present invention, HDO upgrading of feedstock oil at 300° C. and 350° C. in ethanol-water mixed solvent (50/50, w/w) under 35 bar hydrogen gas for 2 h produced an upgraded oil at 18.1 wt. % and 21.2 wt % yield, respectively.

According to a preferred embodiment of the present invention, the upgraded bio-oil has a much lower TAN and viscosity values, as well as increased concentrations of esters, hydrocarbons and phenols and free of carboxylic acids when compared with the feedstock crude bio-oil.

The elemental, GC-MS and FTIR characterizations of upgraded bio-oil suggest effective hydro-de-oxygenation (HDO) and hydro-de-sulfurization (HDS) during the HDO upgrading.

According to a preferred embodiment of the present invention, the upgraded bio-oil at 350° C. has much better quality: much lower TAN (2.5 mg KOH/g), lower viscosity (3.4 cP at 50° C.), and complete solubility in gasoline and VGO than the upgraded oil obtained at 300° C.

In one experiment, a total of 105 grams of upgraded oil was obtained by HDO from the feedstock crude oil at 350° C.

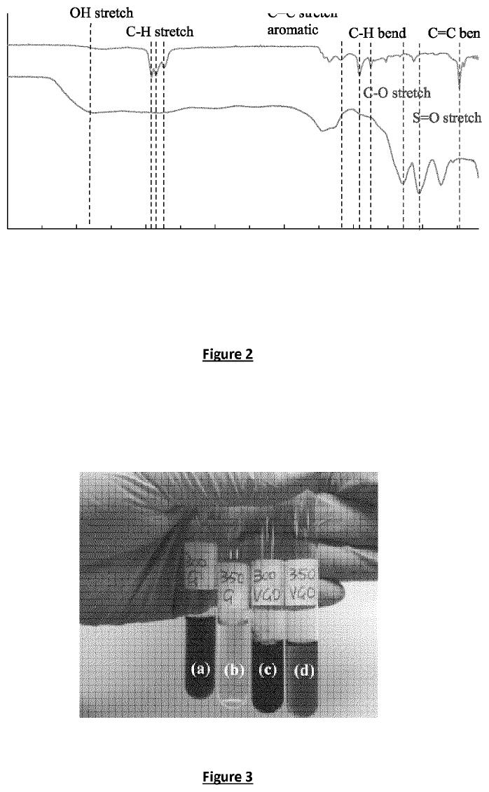

FIG. 3 is a photograph of a 2 wt. % upgraded oil obtained according to a preferred embodiment of the present invention mixed with 98 wt. % gasoline or VGO after ultrasonic agitation for 30 min and standing for 2 h. ((a) 300° C. upgraded oil with gasoline; (b) 350° C. upgraded oil with gasoline; (c) 300° C. upgraded oil with VGO; (d) 350° C. upgraded oil with VGO).

According to a preferred embodiment of the present invention, the produced upgraded bio-oil was utilized as drop-in fuel with hydrocarbon fuels, namely, diesel, jet fuel, and then subjected to ASTM standard testing for the aforementioned hydrocarbon fuels. The third-party ASTM testing results confirmed the suitability of the upgraded oil as a drop-in fuel and met all the ASTM tests conducted by the certified third-party agency.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A method for producing biofuel using a lignin-rich feedstock, said method comprising:
a) providing a lignin-rich feedstock, wherein said lignin-rich feedstock comprises more than 60 wt % of lignin-based compounds obtained from delignification of biomass, wherein said lignin-based compounds are selected from lignin-derived monomers, lignin-derived dimers, lignin-derived oligomers, and combinations thereof;
b) performing a hydrodeoxygenation reaction on said lignin-rich feedstock, wherein the hydrodeoxygenation reaction is carried out in a hydrogen-rich source at a temperature ranging from 250° C. to 400° C. under a H₂ pressure ranging from 15 to 75 bar, in the presence of a catalyst adapted for hydrodeoxygenation (HDO) reactions, for a period of time sufficient to result in an upgraded oil having a total acid number (TAN) of about 10-35 mg KOH/g and a viscosity of 4-30 cP.

2. The method according to claim 1, wherein said feedstock comprises more than 80 wt % of lignin-based compounds obtained from delignification of biomass.

3. The method according to claim 1, wherein said feedstock comprises more than 85 wt % of lignin-based compounds obtained from delignification of biomass.

4. The method according to claim 1, wherein said feedstock comprises more than 90 wt % of lignin-based compounds obtained from delignification of biomass.

5. The method according to claim 1, wherein said feedstock comprises more than 95 wt % of lignin-based compounds obtained from delignification of biomass.

6. The method according to claim 1, wherein said feedstock comprises more than 97.5 wt % of lignin-based compounds obtained from delignification of biomass.

7. The method according to claim 1, wherein said feedstock further comprises a dissolved hemicellulose resulting from a prior delignification reaction that generated said lignin-rich feedstock.

8. The method according to claim 1, wherein said method further comprises a pretreatment procedure using an alkaline salt for removal of sulfuric acid present in a crude bio-oil.

9. The method according to claim 1, wherein said alkaline salt is a hydroxide salt selected from KOH, Ca(OH)₂, and NaOH.

10. The method according to claim 9, wherein said alkaline salt is Ca(OH)₂.

11. The method according to claim 1, wherein said period of time sufficient to result in an upgraded oil having a total acid number (TAN) of about 10-35 mg KOH/g and a viscosity of 4-30 cP is about 2 h.

12. The method according to claim 1, wherein said temperature is about 350° C.

13. The method according to claim 1, wherein said hydrogen-rich source is selected from alcohols and gaseous hydrogen.

14. The method according to claim 1, wherein said upgraded oil has a char content of less than 10 wt.

15. The method according to claim 1, wherein said upgraded oil has a char content of less than 2 wt. %.

16. The method according to claim 1, wherein said upgraded oil has a char content of less than 1 wt. %.

17. The method according to claim 1, further comprising a step of recovering the upgraded oil.

18. A method of producing biofuel using a lignin-rich feedstock, said method comprising:
a) providing a liquid lignin-rich Lignin-Hemicellulose-Depolymerization-Organics (LHDO) feedstock obtained from a delignification process, which separates cellulose from lignin and hemicellulose and depolymerizes lignin and hemicellulose into mainly monomers and dimers thereof;
b) performing a hydrodeoxygenation reaction on said lignin-rich feedstock, wherein the hydrodeoxygenation reaction is carried out in a hydrogen-rich source at a temperature ranging from 250° C. to 400° C. under a H₂ pressure ranging from 15 to 75 bar, in the presence of a catalyst adapted for hydrodeoxygenation (HDO) reactions, for a period of time sufficient to result in an upgraded oil having a total acid number (TAN) of about 10-35 mg KOH/g and a viscosity of 4-30 cP.

19. The method according to claim 18, where said Lignin-Hemicellulose-Depolymerization-Organics (LHDO) contains at most 2% of aldehyde-containing compounds.

20. The method according to claim 1, wherein substantially all carboxylic acids are converted once the Lignin-Hemicellulose-Depolymerization-Organics (LHDO) is upgraded in the hydrodeoxygenation (HDO) reaction.
